(19) United States
(12) Patent Application Publication
(10) Pub. No.: US 2007/0157134 A1
(43) Pub. Date: Jul. 5, 2007

(54) Method for testing a hardware circuit block written in a hardware description language

(75) Inventors: Fu-Chiung Cheng, Taipei City (TW); Nian-Zhi Huang, Taipei City (TW); Jian-Yi Chen, Taipei City (TW)

Correspondence Address: BACON & THOMAS, PLLC, 625 SLATERS LANE, FOURTH FLOOR, ALEXANDRIA, VA, 22314, US

(73) Assignee: Tatung Company, Taipei City (TW)

(21) Appl. No.: 11/407,955

(22) Filed: Apr. 21, 2006

(30) Foreign Application Priority Data
Jan. 3, 2006 (TW) 095100187

(51) Int. Cl. G06F 17/50

(52) U.S. Cl. 716/4; 716/3; 716/18

(57) ABSTRACT

A method for testing a hardware circuit block written in a hardware description language (HDL) is provided, which can automatically produce a test pattern and an error message. The method includes converting an original class into a wrapper class, wherein the wrapper class, as compared to the original class, additionally records all input and output data of the hardware circuit block; producing a top module required for a hardware logic simulation; converting an original unit testing into an extended unit testing; using the extended unit testing to perform a unit testing on the wrapper class to thereby produce an input pattern file; and performing the hardware logic simulation on the hardware circuit block in accordance with the top module and the input pattern file.

### BACKGROUND OF THE INVENTION

1. Field of the Invention

The invention relates to a method for testing a hardware circuit block and, more particularly, to a method for testing a hardware circuit block written in a hardware description language (HDL).

2. Description of Related Art

To increase the efficiency and re-usability of a large-scale circuit design, a hardware description language (HDL) such as VHDL or Verilog is currently used in the design. The codes written in the HDL (HDL codes) is synthesized, placed and routed to thereby correspond to a hardware circuit block, such as a random generator, counter, adder, multiplier or the like. The hardware circuit block is referred to as an intelligent property (IP). A result of executing the HDL codes equals to a result of executing the hardware circuit block. By repeatedly calling the HDL codes, the hardware circuit block can be easily copied, thereby achieving the purpose of reusing a hardware IP.

When a user completely programs the HDL codes, the HDL codes are regarded as a device-under-test (DUT) for being tested to ensure the correctness of the HDL codes. The user also programs a test pattern for the device-under-test. The test pattern further includes a desired result. Next, a simulator system performs a testing on the device-under-test in accordance with the test pattern and compares a test result and the desired result. The aforementioned process is also referred to as a unit test. However, manual labor and time are wasted due to the test pattern written by the user. In addition, when an error occurs on the device-under-test, there is no error reply mechanism available for notifying the user of an appropriate text debug message and the possible error position, which causes the user to have a trouble when a unit test is performed. Therefore, it is strongly desirable to provide an improved method to mitigate and/or obviate the aforementioned problems.

### SUMMARY OF THE INVENTION

The object of the invention is to provide a method for testing a hardware circuit block written in a hardware description language (HDL), which can automatically produce a test pattern and an error message.

To achieve the object, there is provided a method for testing a hardware circuit block written in a hardware description language (HDL). The method includes: (A) converting an original class into a wrapper class, wherein the wrapper class, as compared to the original class, additionally records input and output data of the hardware circuit block; (B) producing a top module required for a hardware logic simulation; (C) converting an original unit testing into an extended unit testing; (D) using the extended unit testing to perform a unit testing on the wrapper class to thereby produce an input pattern file; (E) performing the hardware logic simulation on the hardware circuit block in accordance with the top module and the input pattern file.

Other objects, advantages, and novel features of the invention will become more apparent from the following detailed description when taken in conjunction with the accompanying drawings.

### BRIEF DESCRIPTION OF THE DRAWINGS

FIG. 1 is a flowchart of a method for testing a hardware circuit block written in a hardware description language (HDL) in accordance with the invention;

FIG. 2 is a flowchart of converting an original class into a wrapper class in accordance with the invention; and

FIG. 3 is a schematic diagram of an implementation of FIG. 1 in accordance with the invention.

### DETAILED DESCRIPTION OF THE PREFERRED EMBODIMENT

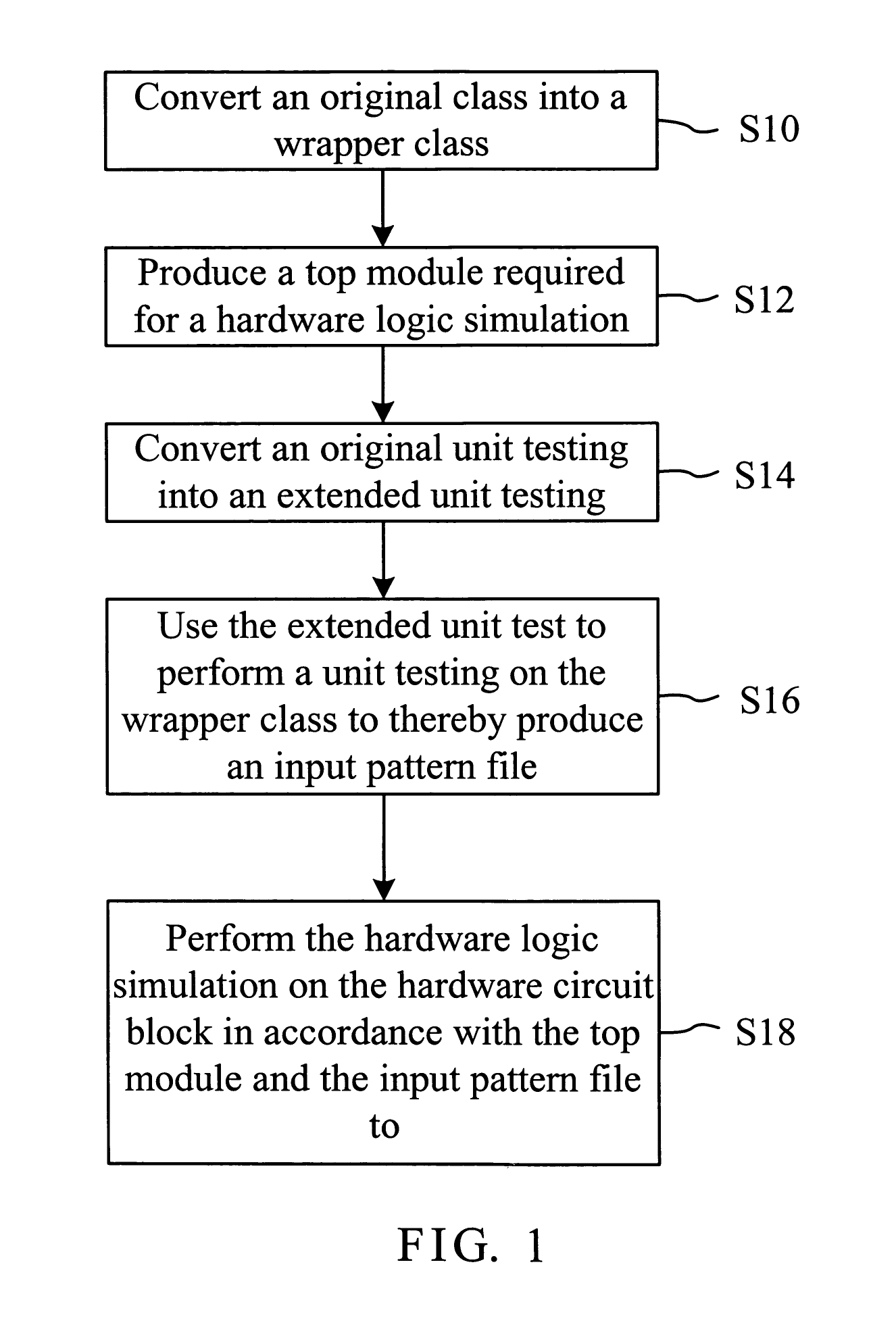

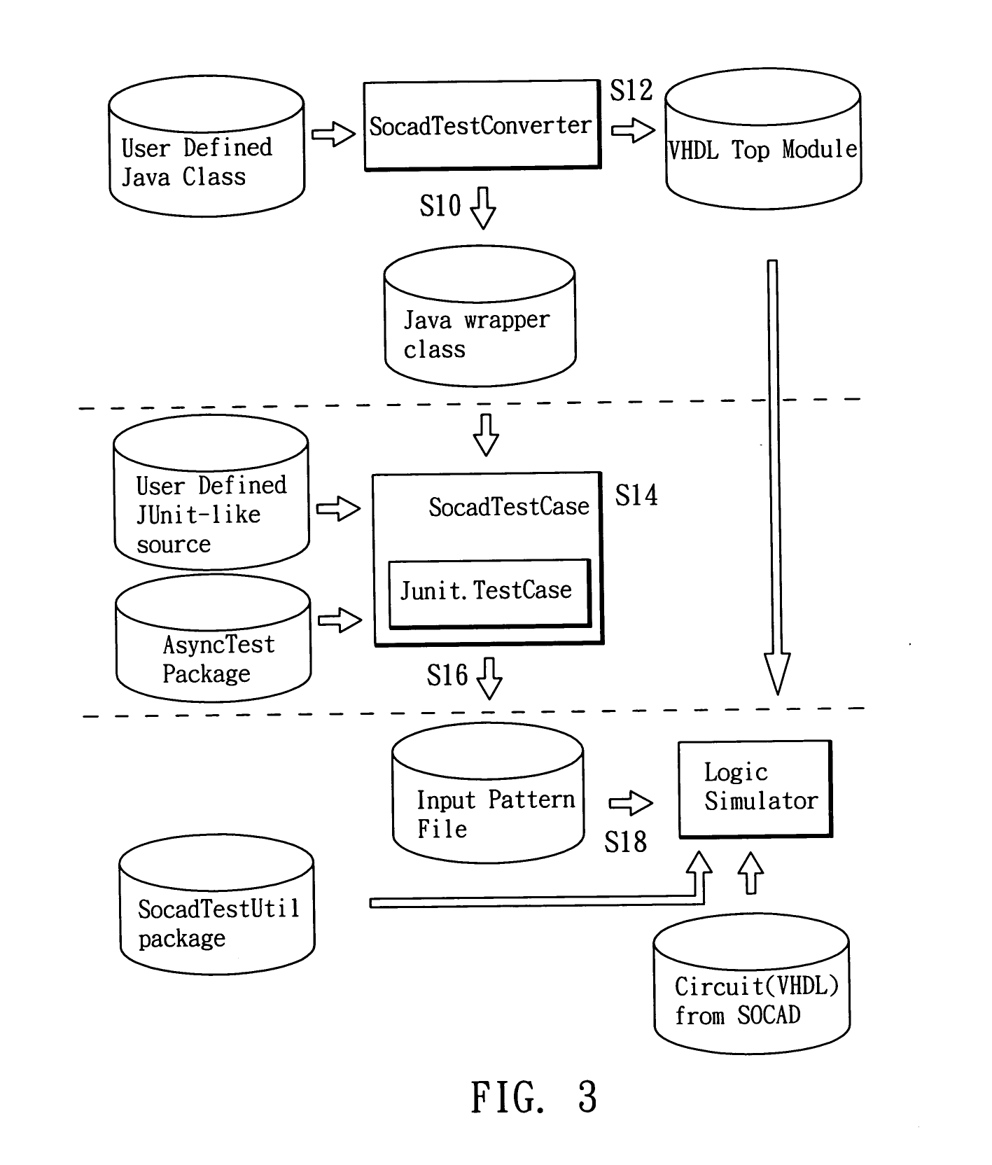

With reference to FIG. 1 which is a flowchart of a method for testing a hardware circuit block written in a hardware description language (HDL), and FIG. 3 which is a schematic view of an implementation of FIG. 1, a Java language is used as the hardware description language (HDL) to program software functions corresponding to a random generator, and the JUnit is used to program test codes for generating a test pattern. In addition, ModeSim provided by Mentor Graphics Cooperation is used as a simulator for the HDL, and an asynchronous 4-phased signal protocol is used as a communication interface for cooperating in the SOCAD system. The above configuration is given for illustrative purpose. An exemplary software function can be provided with a content as follows.

public class Random {

static int va = 3;
static int vb = 8;
static int vcarry = 0;
static int random = 0;
public static void setA(int a) {

va = a; }

public static void setB(int b) {

vb = b; }

public static void setCarry(int carry) {

vcarry = carry; }

public static int simpleRandom( ) {

random = va + vb;

if (vcarry == 1) { random = random+1; }

va = vb;

if (random > = 10) { vcarry = 1; random = random − 10; }

else { vcarry = 0; }

vb = random;
return random;
}

public static void main(String[ ] args) {
for (int i = 0;i<100000;i++) {

Random.setA(i);
Random.setB(i);
Random.setCarry(i);
}
Random.setA(3);
Random.setB(8);
Random.setCarry(0);
for (int i = 0; i<100; i++) {
System.out.println(“i” + i + “RND =” +

Random.simpleRandom( ));

}
System.out.println(“End random”);
}

}

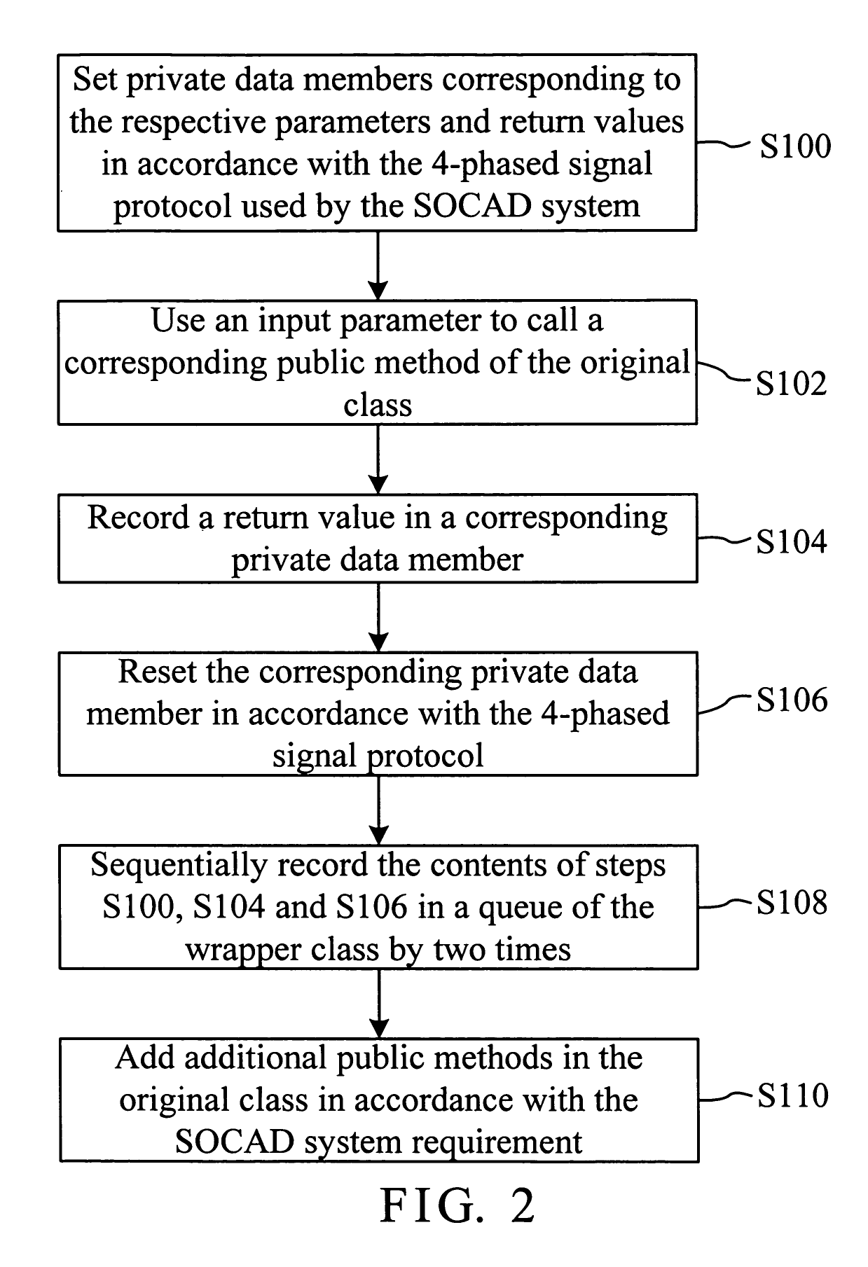

FIG. 1 shows the flowchart of the method for testing a hardware circuit block written in a hardware description language. At first, step S10 converts an original class into a wrapper class. Also with reference to FIG. 2, the original class is a Java class, and the wrapper class is a Java wrapper class. The wrapper class is similar to the original class, both having the same input and output interfaces, but the wrapper class, as compared to the original class, further records input and output data of the software function. In order to successfully converting an action of the software function into a corresponding action of a hardware circuit, the original class is extended in order to record features of the software function on execution, and records the features in a software form. Obviously, the user also records the result during a hardware circuit execution. In this case, the result of executing the software function can be used to predict the result of executing the hardware function by comparing the difference between the two results, thereby ensuring an accurate hardware circuit. The original class is associated with a type of the software function. For example, when the software function describes a random generator, the original class is an extended class required for describing the random generator.

The original class includes public method(s), parameter(s) and return value(s). Accordingly, step S10 additionally defines the public methods, the parameters and the return values as private data members of the wrapper class. As shown in FIG. 2, step S10 further includes the following steps.

Step S100 sets private data members corresponding to the respective parameters and return values in accordance with the 4-phased signal protocol used by the SOCAD system.

Step S102 uses an input parameter to call a corresponding public method of the original class.

Step S104 records a return value in a corresponding private data member.

Step S106 resets the corresponding private data member in accordance with the 4-phased signal protocol.

Step S108 sequentially records the contents of steps S100, S104 and S106 in a queue of the wrapper class by two times.

Step S110 adds the definitions of public methods, such as reset, clear, initialization, in the original class in accordance with the SOCAD system requirement.

Referring again to FIGS. 1 and 3, step S12 produces a top module required for a hardware logic simulation. In this case, the top module indicates a VHDL top module. Because different original classes have different public methods and parameters, the top module required for the hardware logic simulation can be provided to the original class in accordance with the result of step S10. The public methods contained in the original class are known and can be an operating interface to an external device, which are equivalent to input and output ports of a corresponding hardware circuit. Upon a respective port produced in accordance with each public method, the top module can produce input patterns with respect to all input ports and records executing result through the respective output ports. In addition, the top module can also read the text debug information of the test pattern to thereby provide an appropriate debug information corresponding to errors by the user when the errors occur. The top module can be provided with an exemplary content as follows.

while (input pattern file != EOF)
{
for every public method {

for every input interface{

read set-data from input pattern file;
send the set-data to the hardware input-interface;

}

}
wait for the maximum delay;
read data from hardware output interfaces;
read the set-records from input pattern file;
if(read-data ! = set-records)

{
pass the assert message from input pattern file to stand

output;

exit;
}

for every public method{

for every input interface{

read reset-data from input pattern file;
send the read-data to hardware input interface;

}

}
wait for the maximum delay;
read data from hardware output interface;
read the reset-records from the input pattern file;
if(read-data != reset-records)

{
pass the assert message from input pattern file to stand

output;

exit;
}

}

Step S14 converts the original unit testing into an extended unit testing. In order to match an error position occurred in a simulation for a hardware behavior with a corresponding software description, the hardware behavior is divided into blocks, each corresponding to a text debug message. To achieve the object, the executed hardware actions between a current assert function and the last called assert function are recorded. A SOCAD_ASSERT function has two essential features: one for converting the record in step S108 into a text input pattern and storing the text input pattern in an input pattern file, and the other one for appropriately modifying the collected text debug messages for integrating with the input pattern file. Accordingly, the SOCAD_ASSERT function can integrate hardware execution behaviors with text debug messages that are collected from the wrapper class and output to a test pattern file. In accordance with the queue in step S108 and the 4-phased signal protocol used by the SOCAD system, the last second action in the queue is a computation phase along with a SOCAD_ASSERT call, and the last action is a reset phase corresponding to the computation phase. Thus, the user can implement a unit testing by extending the original assert_function through the following pseudo codes.

SOCAD_ASSERT EQUAL(Message, Condition){

original_assert_equal(Message, Condition);
MSG = “BEFORE” + Message;
for(i = 0; i<wrapper_class.queue.length − 2;i ++)
{

write_data_to file(wrapper_class.queue.get(i),MSG);

}
MSG = “Computation “ + Messgae;

write_data_to_file(wrapper_class.queue.get(i,MSG));
i=i+1;
MSG = “Reset “ + Message;
write_data_to_file(wrapper_class.queue.get(i,MSG));
wrapper_class.queue.flush( );

}

In case of an action without any assert message, the action is labeled with another message consisting of an immediately following assert message plus a “Before” string to thereby divide all behaviors on a hardware logic simulation into blocks by using text debug messages as boundary lines.

Step S16 uses the extended unit testing to perform the unit testing on the wrapper class to thereby produce the input pattern file. The behavior of the original unit testing is a subset of all behaviors during the process. Because the wrapper class, in addition to the descriptions of the original class, also adds the actions corresponding to the hardware circuit blocks, and the original unit testing is changed into the extended unit testing, the extended unit testing is used to perform the unit testing on the wrapper class to thus produce the input pattern file. The input pattern file includes the hardware actions corresponding to the unit testing, the text debug messages used by the unit testing and the divided blocks of the hardware logic simulation behavior.

Step S18 performs the hardware logic simulation on the hardware circuit block based on the top module and the input pattern file. SOCAD can convert a software method into a hardware circuit block, and uses Modelsim simulator to perform the hardware logic simulation in accordance with the top module and the input pattern file. When a comparison result is affirmative, the subsequent operations are executed; otherwise, the top module can display an appropriate assert message in accordance with the input pattern file. For example, during the hardware logic simulation, a content of the assert message is shown as follows.

Error

In Function testRandom: In 8th interation Computing

Interface: retsimpleRandoml, expected=0000000010, but actual=0000000001

Time: 68us Iteration:0 Instance:/random_test_top

From the above, the user can refer to a call “simplerandom(ture)” in the exemplary content of the original unit testing, which shows a desired result of two but the hardware logic simulation returns one, further, an error obtained in the assert message occurs at the 9-th (zero to eight) time for loop execution. It is assumed that a content of the assert message is shown as follows.

Error

In Function testRandom: BEFORE In 0th interation Computing

Interface: bAck4P, expected=1, but actual=0

Time: 34us Iteration:0 Instance:/random_test_top

From the above, the user can obtain an error occurred before a loop execution at an interface “bAck4P”. Accordingly, the error is determined to occur at a segment “ThisRandom.setB(8, false)”. By the cited two examples, the user can determine corresponding error positions in accordance with the content of the assert message, and correct the errors.

Although the present invention has been explained in relation to its preferred embodiment, it is to be understood that many other possible modifications and variations can be made without departing from the spirit and scope of the invention as hereinafter claimed.

What is claimed is:

1. A method for testing a hardware circuit block written in a hardware description language, comprising the steps of:
(A) converting an original class into a wrapper class, wherein the wrapper class, as compared to the original class, additionally records input and output data of the hardware circuit block;
(B) producing a top module required for a hardware logic simulation;
(C) converting an original unit testing into an extended unit testing;
(D) using the extended unit testing to perform a unit testing on the wrapper class to thereby produce an input pattern file; and
(E) performing the hardware logic simulation on the hardware circuit block in accordance with the top module and the input pattern file.

2. The method as claimed in claim 1, wherein step (A) comprises the steps of:
(A1) setting a private data member corresponding to an input parameter and return value in accordance with a selected signal protocol;
(A2) recording the input parameter in the private data member;
(A3) recording the return value in the private data member;
(A4) resetting the private data member in accordance with the selected signal protocol;
(A5) sequentially recording all contents of steps (A1), A(3) and A(4) in a queue of the wrapper class; and
(A6) defining public method that re not defined in the original class.

3. The method as claimed in claim 1, wherein the hardware description language is VHDL or Verilog.

4. The method as claimed in claim 1, wherein the hardware description language is coded by a Java language.

5. The method as claimed in claim 2, wherein the selected signal protocol is an asynchronous 4-phased signal protocol applied to the hardware circuit block.
